(19) United States
(12) Patent Application Publication
(10) Pub. No.: US 2025/0058397 A1
(43) Pub. Date: Feb. 20, 2025

(54) Submerged Arc Welding Machine and Submerged Arc Welding Method

(71) Applicant: DAIHEN Corporation, Osaka (JP)

(72) Inventors: Hayato Baba, Osaka (JP); Reo Honda, Osaka (JP)

(21) Appl. No.: 18/794,348

(22) Filed: Aug. 5, 2024

(30) Foreign Application Priority Data
Aug. 18, 2023 (JP) 2023-133553

(51) Int. Cl. B23K 9/095; B23K 9/18

(52) U.S. Cl. CPC B23K 9/0956; B23K 9/18

(57) ABSTRACT

Provided is a submerged arc welding method including: receiving setting of a gain indicating responsiveness of a variation in a feeding speed of a welding wire with respect to a variation in an arc length; detecting a welding voltage corresponding to the arc length; controlling the arc length by changing the feeding speed of the welding wire on the basis of the detected voltage, and controlling the arc length by changing the feeding speed of the welding wire on the basis of the detected voltage, a predetermined voltage corresponding to a predetermined arc length, and the received gain.

### REFERENCE TO RELATED APPLICATIONS

This application claims priority from Japanese Patent Application No. 2023-133553 filed on Aug. 18, 2023. The entire content of the priority application is incorporated herein by reference.

### BACKGROUND

A submerged arc welding method capable of controlling an arc length by variable feeding speed control that changes a feeding speed of a welding wire in correspondence with a welding voltage is disclosed (for example, Japanese Patent Laid-Open Publication No. H9-271944)

In the variable feeding speed control, an arc voltage indicating an arc length is constantly maintained by sequentially changing the wire feeding speed. In submerged arc welding using a large-diameter wire, even when a welding current slightly varies, a wire melting rate is less likely to vary, and an arc length self-control operation that is typically used in GMA welding using a welding power supply with a constant voltage characteristic is less likely to be obtained, and thus it is known that the variable feeding speed control is effective for arc length control.

In the variable feeding speed control, for example, a feeding speed or a correction amount of the feeding speed is determined in correspondence with an effective value or an average value of the welding voltage (arc voltage) or a difference in the effective value or the average value between a setting voltage or the welding voltage.

In a case where the effective value or the average value of the welding voltage is large, or in a case where the effective value or the average value of the welding voltage is larger as compared with the setting voltage, the arc length is large. In this case, the arc length is made smaller by adjusting the feeding speed to be larger, and the effective value or the average value of the welding voltage associated with the arc length is controlled to be smaller. The same is also true of the opposite case.

In the above-described control, the larger the amount of variation in the feeding speed to the amount of variation in the voltage is, the larger the amount of manipulation of the feeding speed becomes, and the smaller the variation in the effective value or the average value in the welding voltage indicating the arc length becomes. However, when the amount of variation in the feeding speed with respect to the amount of variation in the voltage is excessively larger, it enters a so-called high-gain state, and thus the feeding speed and the effective value or the average value of the welding voltage fluctuate, and welding becomes unstable. In addition, even though vibration is not caused, the larger the amount of variation in the feeding speed is, the faster a degradation speed of an equipment around wire feeding such as a feeding gear and a tip becomes.

Note that, in an analog feeding control device for submerged welding in the related art, a configuration in which a voltage adjustment scale or a feeding gear ratio is changed results in variation in responsiveness of the feeding speed corresponding to voltage information. However, in the same feeding device, only the responsiveness of the feeding speed cannot vary, and the feeding speed and the effective value or the average value of the voltage also vary simultaneously. A convergence value of the effective value or the average value of the voltage is one of the most important factors for adjusting welding conditions, and the convergence value of the effective value or the average value of the voltage is adjusted with the highest priority so that stable welding can be performed and a desired arc length and a desired penetration depth can be obtained. The responsiveness of the feeding speed corresponding to the voltage information is determined only as a result. That is, in a welding system in the related art, the responsiveness of the feeding speed cannot be manipulated independently.

### SUMMARY

An object of the present disclosure is to provide a submerged arc welding machine and a submerged arc welding method which are capable of manually adjusting responsiveness of a wire feeding speed with respect to a variation in an arc length (variation in a welding voltage) in submerged arc welding in which the arc length is controlled by variable feeding speed control.

A submerged arc welding machine according to an aspect of the present disclosure includes: a wire feeding device configured to feed a welding wire; a voltage sensor configured to detect a welding voltage corresponding to an arc length; a control device configured to control the arc length by changing a feeding speed of the welding wire by the wire feeding device on the basis of the welding voltage detected by the voltage sensor; and a setting reception unit configured to receive setting of a gain indicating responsiveness of a variation in the feeding speed of the welding wire with respect to a variation in the arc length. The control device determines the feeding speed of the welding wire by the wire feeding device on the basis of the welding voltage detected by the voltage sensor, a predetermined voltage corresponding to a predetermined arc length, and the gain received by the setting reception unit.

A submerged arc welding method according to another aspect of the present disclosure includes: receiving setting of a gain indicating responsiveness of a variation in a feeding speed of a welding wire with respect to a variation in an arc length; detecting a welding voltage corresponding to the arc length; and controlling the arc length by changing the feeding speed of the welding wire on the basis of the detected welding voltage, a predetermined voltage corresponding to a predetermined arc length, and the received gain.

According to the aspects of the present disclosure, in submerged arc welding in which an arc length is controlled by variable feeding speed control, it is possible to manually adjust responsiveness of a wire feeding speed with respect to a variation in the arc length.

The above and further objects and features will more fully be apparent from the following detailed description with accompanying drawings.

### BRIEF DESCRIPTION OF SEVERAL VIEWS OF DRAWINGS

FIG. 1 is a schematic view illustrating a configuration of a submerged arc welding machine according to the present embodiment;

FIG. 2 is a block diagram illustrating a configuration of the submerged arc welding machine according to the present embodiment; and

FIG. 3 is a flowchart illustrating a control method according to the present embodiment.

### DESCRIPTION

Specific examples of a submerged arc welding machine and a submerged arc welding method according to an embodiment of the present disclosure will be described with reference to the accompanying drawings. Note that, the invention is not limited to the examples, and is represented by the appended claims, and it is intended to include meaning equivalent to the appended claims and all modifications in the scope.

Hereinafter, the invention will be described in detail on the basis of the drawings illustrating an embodiment.

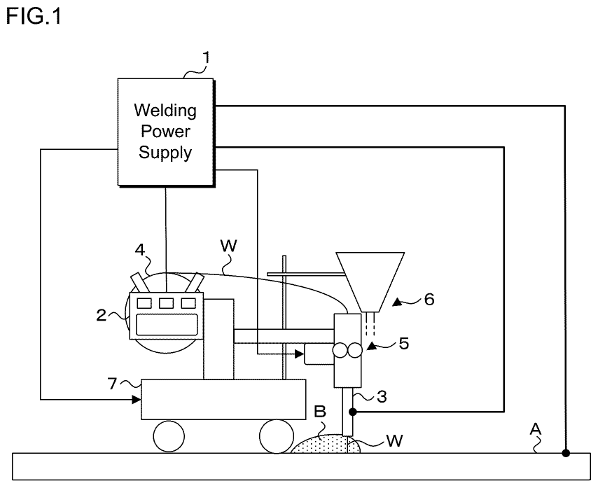

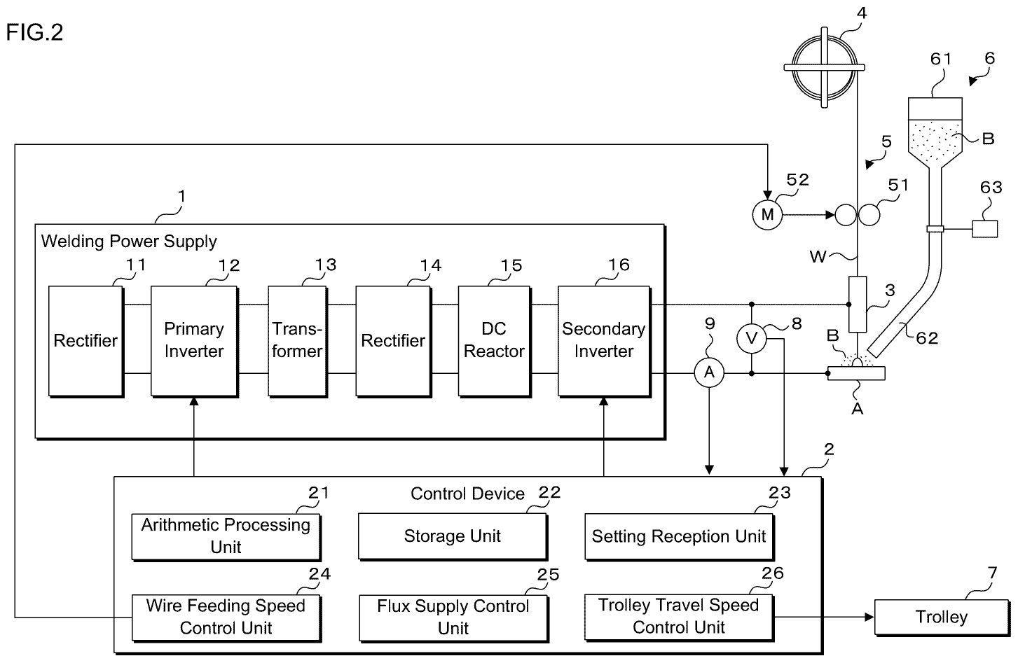

FIG. 1 is a schematic view illustrating a configuration of a submerged arc welding machine according to the present embodiment, and FIG. 2 is a block diagram illustrating a configuration of the submerged arc welding machine according to the present embodiment. The submerged arc welding machine according to the present embodiment includes a welding power supply 1, a control device 2, a torch 3, a wire reel 4, a wire feeding device 5, a flux supply device 6, a trolley 7, a voltage sensor 8, and a current sensor 9. The submerged arc welding machine according to the present embodiment is a welding system in which a user can manually adjust the amount of adjustment (gain) in a wire feeding speed with respect to a difference between a setting voltage and a welding voltage.

The torch 3 is formed from a conductive material such as a copper alloy, and includes a cylindrical contact tip that guides a welding wire W to a portion-to-be-welded of a base material A, and supplies a welding current necessary for occurrence of arc. The contact tip comes into contact with the welding wire W that is inserted into the contact tip and supplies the welding current to the welding wire W.

The wire feeding device 5 includes a feeding roller 51 that pulls out the welding wire W wound around the wire reel 4 and feeds the welding wire W to the torch 3, and a motor 52 that rotates the feeding roller 51. The wire feeding device 5 feeds the welding wire W to the torch 3 by rotating the feeding roller 51. A feeding rate of the welding wire W is adjusted in correspondence with a welding voltage so that an arc length does not fluctuate. The feeding rate of the welding wire W by the wire feeding device 5 is controlled by the control device 2.

The flux supply device 6 includes a flux hopper 61, a nozzle 62, a valve, 63, a flux recovery machine (not illustrated), and the like. The flux hopper 61 stores a flux B that is put from an upper side, and the flux B is supplied to the portion-to-be-welded of the base material A through the nozzle 62 connected to a lower side of the flux hopper 61. The valve 63 opens or closes a route from the flux hopper 61 to the nozzle 62, and adjusts the supply amount of the flux B. The opening/closing and the amount of opening/closing of the valve 63 are controlled by the control device 2. Note that, the opening/closing and the amount of opening/closing of the valve 63 may be configured to be manually manipulated.

The trolley 7 is a transport device on which the welding power supply 1, the control device 2, the torch 3, the wire reel 4, the wire feeding device 5, the flux supply device 6, and the like are mounted, and moves along a welding line of a base material A. The trolley 7 includes a travel motor that rotates wheels. The torch 3 and the flux supply device 6 move along the welding line of the base material A due to the traveling trolley 7, the granular flux B stored in the flux hopper 61 is scattered along the welding line, and the welding wire W is fed into the flux B by the wire feeding device 5. A travel speed of the trolley 7 is controlled by the control device 2.

The voltage sensor 8 is a sensor that detects a voltage between an arc voltage detection lead wire attached to the torch 3 and an arc voltage detection lead wire attached to the base material A as a welding voltage (arc voltage), and outputs a voltage value signal indicating a detected voltage value to the control device 2.

The current sensor 9 is a sensor that detects a welding current that is supplied from the welding power supply 1 to the welding wire W through the torch 3, and flows to the base material A through the arc, and outputs a current value signal indicating a detected current value to the control device 2.

The welding power supply 1 is an inverter-controlled AC welding power supply having a constant current characteristic, and includes a rectifier 11, a primary inverter 12, a transformer 13, a rectifier 14, a DC reactor 15, and a secondary inverter 16 which are sequentially connected in series from an input side of a commercially available power supply. The welding power supply 1 is connected to the contact tip of the torch 3 and the base material A through a power supply cable. The welding power supply 1 supplies a welding power between the welding wire W and the base material A by using the commercially available power supply as an input to generate an arc.

The rectifier 11 rectifies an alternating current of the commercially available power supply and outputs the rectified current to the primary inverter 12. The primary inverter 12 is driven at a high frequency of dozen kHz to several tens of kHz, and applies a high-frequency alternating current to a primary coil of the transformer 13. The transformer 13 transforms the alternating current and the transformed alternating current is rectified by the rectifier 14, and is output to the secondary inverter 16 through the DC reactor 15. The secondary inverter 16 is driven at a low frequency of several tens of Hz to several hundreds of Hz, and outputs a low-frequency alternating current. Due to output of the alternating current, an AC welding voltage is applied between the torch 3 and the base material A, and the welding current supplied from the welding power supply 1 flows from the torch 3 to the welding wire W through a power supply cable. Welding of the base material A is performed by heat of an arc generated between the base material A and the welding wire W due to the welding current. The arc is covered with the flux B supplied by the flux supply device 6.

The control device 2 is a circuit that outputs a control signal to each of the primary inverter 12 and the secondary inverter 16 of the welding power supply 1, and independently digitally controls the inverters. In addition, the control device 2 controls a feeding speed of the welding wire W by the wire feeding device 5, the supply amount of the flux B by the flux supply device 6, a travel speed of the trolley 7, and the like.

The control device 2 is a processor, and includes an arithmetic processing unit 21 such as a CPU and a multi-core CPU, a storage unit (storage) 22, a setting reception unit 23, a wire feeding speed control unit 24, a flux supply control unit 25, and a trolley travel speed control unit 26.

The storage unit 22 is a storage device including a non-volatile memory such as a read only memory (ROM) and EEPROM, a volatile memory such as a random access memory (RAM). In addition, the storage unit 22 stores a proportional gain related to the responsiveness of the variable feeding speed control.

The setting reception unit 23 is an input device such as a button, a key, and a dial, and receives setting information including a setting current of the submerged arc welding machine, a wire diameter of the welding wire W, a type of the welding wire W, a proportional gain related to responsiveness of the variable feeding speed control, and other welding conditions. The proportional gain is a numerical value indicating the responsiveness of the feeding speed variation of the welding wire W with respect to a variation in the arc length. More specifically, the proportional gain represents a relationship of the amount of variation in the feeding speed of the welding wire W with respect to a difference between an average value of the welding voltage detected by the voltage sensor 8 (an average value of an absolute value of the welding voltage in a case of AC welding) or an effective value thereof and a setting voltage (predetermined voltage) corresponding to a predetermined arc length.

The wire feeding speed control unit 24 is connected to a drive circuit of the motor 52, and outputs a rotation control signal corresponding to a wire feeding speed to the drive circuit to control feeding of the welding wire W by the wire feeding device 5. The feeding roller 51 rotates at a speed corresponding to the rotation control signal, and the welding wire W is fed to the portion-to-be-welded of the base material A through the torch 3.

The arc length is proportional to the welding voltage (arc voltage). The welding voltage is a voltage between the contact tip of the torch 3 and the base material A and is detected by the voltage sensor 8. A feeding speed setting value that is a target value is set in the wire feeding speed control unit 24. The wire feeding speed control unit 24 controls the feeding speed of the welding wire W so that the arc length becomes constant by using the difference between the feeding speed setting value, and the average value or the effective value of the welding voltage detected by the voltage sensor 8 as the amount of manipulation.

The flux supply control unit 25 is connected to a drive circuit that opens or closes the valve 63 of the flux supply device 6, and outputs an opening/closing signal corresponding to the supply amount of the flux to the drive circuit to control the supply of the flux B by the flux supply device 6. Note that, in a case where the opening/closing of the valve 63 is manually manipulated, the flux supply control unit 25 is not used.

The trolley travel speed control unit 26 is connected to a drive circuit that drives a travel motor of the trolley 7, and outputs a travel control signal corresponding to a travel speed of the trolley 7 to the drive circuit to control traveling of the trolley 7.

In addition, the voltage sensor 8, the current sensor 9, the primary inverter 12, and the secondary inverter 16 are connected to a signal input/output terminal (not illustrated) of the control device 2, and the control device 2 PWM-controls the primary inverter 12 to operate in a constant current characteristic on the basis of the welding condition that is set, and the welding current and the welding voltage which are detected. A predetermined welding voltage is applied between the base material A and the welding wire W, and a welding current flows therebetween.

The above-described wire feeding speed control unit 24 can stabilize welding by controlling the arc length by variable feeding speed control of the welding wire W. Particularly, the submerged arc welding machine according to the present embodiment is configured so that a user can manually adjust responsiveness of the wire feeding speed corresponding to the welding voltage, and particularly, the proportional gain that is easy for a user to understand is used as a parameter for adjusting responsiveness.

For example, consideration will be given to a case where the average value of the welding voltage (an average value of an absolute value of the welding voltage in a case of AC welding) is fed back, and the feeding speed is PI-controlled so that a difference between the average value and the setting voltage decreases. At this time, as a parameter for manipulating the feeding responsiveness, a proportional (P) gain and an integrated (I) gain can be exemplified. In addition, time for taking the average value of the welding voltage (time for taking a moving average of n cycles of AC, time for taking a total average from the start of welding to the present time, or the like), and a control cycle (an update period of a feeding speed command value) also become the parameter for manipulating the feeding responsiveness.

Among the parameters, the effect of the proportional (P) gain is relatively easy to understand. When the proportional (P) gain is adjusted to be larger, a variation in the feeding speed is large, and a voltage variation decreases. When the gain is adjusted to be smaller, the variation in the feeding speed is small, and the voltage variation increases. On the other hand, regarding the latter three, it is not easy for a general user to understand the meaning of each parameter, and adjustment is difficult.

Here, there is provided a submerged arc welding system in which the proportional (P) gain is set as a parameter with a name and meaning such as “feeding responsiveness”, and only this parameter is allowed to be adjusted by the user. According to this, adjustment of the feeding responsiveness by the user becomes possible, and adjustment can be made to an optimal value corresponding to a situation.

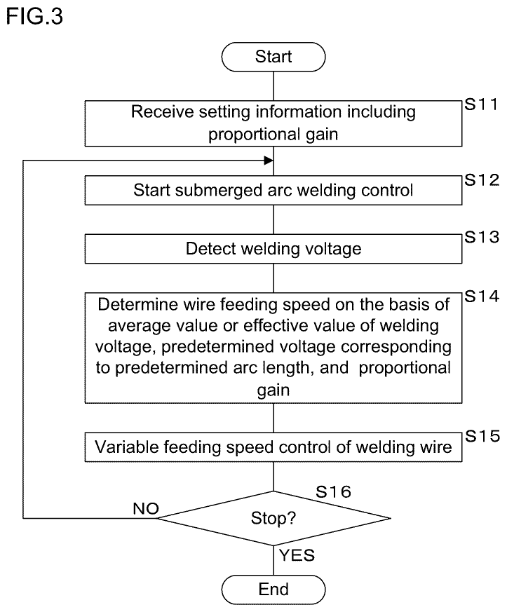

FIG. 3 is a flowchart illustrating the control method according to the present embodiment. In the following description, arc length control and travel speed control will be mainly described, and other details of the arc welding control will be omitted or simplified. The control device 2 receives setting information including a setting current of the submerged arc welding machine, a wire diameter of the welding wire W, the type of the welding wire W, the proportional gain related to the responsiveness of the variable feeding speed control, and other welding conditions (step S11), and starts the submerged arc welding control (step S12).

Next, the control device 2 detects the welding voltage by the voltage sensor 8 (step S13). Then, the control device 2 determines the wire feeding speed on the basis of a difference between an average value or an effective value of the detected welding voltage, and the setting voltage (predetermined voltage) (step S14).

Then, the control device 2 performs variable feeding speed control of the welding wire W by the determined wire feeding speed (step S15). Specifically, the control device 2 performs PI control so that the average value or the effective value of the detected welding voltage becomes close to the setting voltage as a target voltage by using the proportional gain received in step S11 and a predetermined integrated gain. The integrated gain is a fixed value set to the control device 2 in advance.

The setting voltage is a voltage when the arc length is a predetermined length. It is possible to constantly maintain the arc length by making the average value or the effective value of the welding voltage and the setting voltage match each other. The control device 2 determines forward rotation or reverse rotation of the motor 52 on the basis of a sign of a difference voltage between the average value or the effective value of the detected welding voltage and the setting voltage, and determines the wire feeding speed by a value of the difference voltage. Specifically, in a case where the difference voltage, that is, (the average value or the effective value of the detected welding voltage)−(the setting voltage) is positive, the control device 2 increases the wire feeding speed, and in a case where the difference voltage, that is, (the average value or the effective value of the detected welding voltage)−(the setting voltage) is negative, the control device 2 decreases the wire feeding speed. The amount of increase or decrease of the wire feeding speed with respect to the difference voltage is proportional to a value of the proportional gain.

Hereinafter, the control device 2 determines whether or not a predetermined termination condition is satisfied (step S16), and terminates the welding process in a case where the termination condition is satisfied (step S16: YES). In a case where the termination condition is not satisfied (step S16: NO), the control device 2 repetitively executes the processes from step S12 to step S15, and executes the submerged arc welding method.

As described above, according to the submerged arc welding machine and the submerged arc welding method according to the present embodiment, in the submerged arc welding in which the arc length is controlled by the variable feeding speed control, the responsiveness of the wire feeding speed with respect to a variation in the arc length can be manually adjusted.

Note that, in the present embodiment, description has been given of an example in which the proportional gain is received and the responsiveness of the wire feeding speed with respect to a variation in the arc length is adjusted, but a user may manipulate or select a combination of a plurality of manipulation parameters prepared in advance such as a combination in which the proportional (P) gain and the integrated (I) gain are changed in association with each other.

The feeding control method is not limited to the above-described PI control, and control may be performed by PD control, PID control, and other known methods. A differential gain in the PD control and the PID control is also set as a fixed value as in the integrated gain.

In addition, the manipulation parameter for determining the responsiveness of the wire feeding speed with respect to the variation in the arc length is also not limited to the above-described contents.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

What is claimed is:

1. A submerged arc welding machine, comprising:
a wire feeding device configured to feed a welding wire;
a voltage sensor configured to detect a welding voltage;
a control device configured to control an arc length by changing a feeding speed of the welding wire by the wire feeding device on the basis of the welding voltage detected by the voltage sensor; and
a setting reception unit configured to receive setting of a gain indicating responsiveness of a variation in the feeding speed of the welding wire with respect to a variation in the arc length,
wherein the control device determines
the feeding speed of the welding wire by the wire feeding device on the basis of the welding voltage detected by the voltage sensor, a predetermined voltage corresponding to a predetermined arc length, and the gain received by the setting reception unit.

2. The submerged arc welding machine according to claim 1,
wherein the gain includes
a proportional gain indicating a relationship of the amount of variation in the feeding speed of the welding wire with respect to a difference between an average value or an effective value of the welding voltage detected by the voltage sensor and the predetermined voltage corresponding to the predetermined arc length.

3. A submerged arc welding method, comprising:
receiving setting of a gain indicating responsiveness of a variation in a feeding speed of a welding wire with respect to a variation in an arc length;
detecting a welding voltage; and
controlling the arc length by changing the feeding speed of the welding wire on the basis of the detected welding voltage, a predetermined voltage corresponding to a predetermined arc length, and the received gain.
